(19) United States
(12) Patent Application Publication
(10) Pub. No.: US 2010/0205004 A1
(43) Pub. Date: Aug. 12, 2010

(54) METHOD OF PATIENT-STAFF ANALYTICS

(76) Inventor: Grant Aldrich, Newport Beach, CA (US)

Correspondence Address: John Alumit, 16830 Ventura Blvd. Suite 360, Encino, CA, 91436, US

(21) Appl. No.: 12/368,155

(22) Filed: Feb. 9, 2009

(51) Int. Cl. G06Q 99/00; G06Q 50/00

(52) U.S. Cl. 705/3; 705/11

(57) ABSTRACT

A method of patient and medical practitioner analysis of which a patient obtains a vanity phone number to a medical practitioner from a website. The phone calls are digitally recorded and saved in a database for a computer software to communicate with the database and securely download the saved patient documentation. A secure website interface accessible with internet capable devices then provides medical practitioners with the saved patient documentation such as: digital sound files, phone call logistics, and web logistic. Medical practitioners may then assign additional information to the secure website interface about patient attributes and conditions. The web analytic computer software application generates visuals of analysis and statistics representing compiled information for medical practitioners to compare staff performance, relative booking percentages, revenues generated, website interface visitor information, and marketing resources within the environment, including data compiled by other practitioners.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates to a new field of patient and staff interaction analytics practiced in the medical industry and particularly in the field of dermatology and plastic surgery.

There is no readily accessible way for medical practices to monitor patient-staff interaction in any objective or quantifiable manner. Valuable data about the staff's ability to address the concerns and needs of potential patients is often lost during the patient-staff interaction due to lack of reporting mechanisms and poor internal communication. Medical practices are unable to determine whether potential revenue is lost due to poor staff performance, whether marketing strategies are successful, or whether the practice is properly allocating its resources into capital investments in treatments or devices driven by market demand. Needless to say, this lack of oversight causes medical practices to incur significant loss of potential revenue.

Known in the art are quality control call centers within an organization, or third-party quality control centers, that record telephone calls for quality assurance purposes. For example, U.S. Pat. No. 6,724,887 to Lubowsky discloses a contact center which records and analyzes customer communications. The contact center includes a monitoring system which records customer communications and reviews the communications to identify parameters of the communications and determines whether the parameters of the customer communications indicate a negative or unsatisfactory experience. The analyzing unit performs a stress analysis on telephone calls to determine a stress parameter by processing the audio portions of the telephone calls to ultimately determine whether the experience of the caller was satisfactory or unsatisfactory. However, such services are normally offered by consultants seeking to provide general advice for enhancing performance within a large organization. Such services are normally not affordable for smaller medical practices interested in learning how well they perform with respect to other small medical practices. Furthermore, such method is intended to be provided infrequently using set parameters, and does not allow the practitioner to constantly interact with the quality assurance system directly over a long period of time.

Furthermore, obtaining survey data from various businesses through questionnaires is known for the purposes of comparing the performance of the various staffs of each office. However, one problem with surveys is in obtaining accurate data from staff because staff employees may not be truthful in their interactions with clients. Methods for recording telephone conversations for the purposes of obtaining objective data needed to compile comparative reports across the medical sector, while at the same time being able to access actual recorded conversations to hold staff accountable or to use as specific examples of performance quality, has yet to be explored.

It is therefore, an object of the present invention to quantitatively and objectively analyze staff performance and marketing return on investment (ROI), and to track patient demand across various procedures, through an automated online web application, wherein the web application tracks and sorts incoming phone calls, and generates reports that determine patient conversion, staff performance, marketing effectiveness, patient interests, and call outcomes, and then provides a comparative analysis report with similar medical practices.

### SUMMARY

The present invention comprises a method of analysis between parties utilizing computer software. In the preferred embodiment of the method, a patient first acquires a vanity phone number corresponding to a medical practitioner from a website. The phone calls made with the vanity phone number are automatically documented and saved securely in a database, wherein the documented phone calls are digitally recorded conversations. The database comprising documentation may be created with SQL Server, Oracle, MySQL, SQLite, or DB2. In an alternate embodiment of the method, documentation services may be provided by a 3^{rd} party voice over internet protocol.

In step 2 of the preferred embodiment, computer software communicates with the database to securely download the compiled documentation corresponding to the vanity phone numbers, wherein the user (medical practitioner) may access the recorded telephone conversations. The computer software that communicates with the information database may be created with PHP, Java, Ruby, Python, C++, Perl, or .NET languages such as C#, or VB.Net.

In step 3 of the method, a secure website interface, accessible by personal computers, handheld devices, cell phones, or mobile devices having internet access, provides medical practitioners with patient documentation including: digital sound files, phone call logistics, including date and time of call, length of call, and caller phone number.

In step 4 of the method, the secure website interface application comprises a means for allowing the medical practitioner to assign additional fields to the interface wherein the additional fields include: purpose of call, call outcomes, additional booking leads, patient condition, gender and social demographics, marketing source, revenue generated, treatment history, and condition to be treated (also known as tagging). The secure website interface application also provides a means for downloading data from the medical practitioner's internal Contact Relationship Management (CRM), patient history, or billing software.

In step 5 of the method, the computer software comprising the web analytics application comprises a means for generating statistical information based on the fields. In the preferred embodiment of the web analytics application, manual and/or automatic customization features for medical practitioners include: all fields in the secure website interface, as well as relative new patient leads booking an appointment, relative booking percentage by condition, percentage and number of new patient leads booking an appointment, percentage and number of existing patient bookings generated, percentage and number of calls going to the answering service, percentage and number of calls hanging up, percentage and number of calls from telemarketers. In an alternative embodiment, fields can be generated based on anonymous visitor data including geographic location based on the IP address.

In step 6, the computer software comprising the web analytic application of the method, comprises a means for allowing medical practitioners to anonymously compare results with other participating medical practitioners by generating comparative statistical analysis based on the same fields input.

### BRIEF DESCRIPTION OF THE FIGURES

FIG. 1 is a flow chart showing all components of method.

FIG. 2 is a flow chart showing a method with variations in the components.

### DETAILED DESCRIPTION

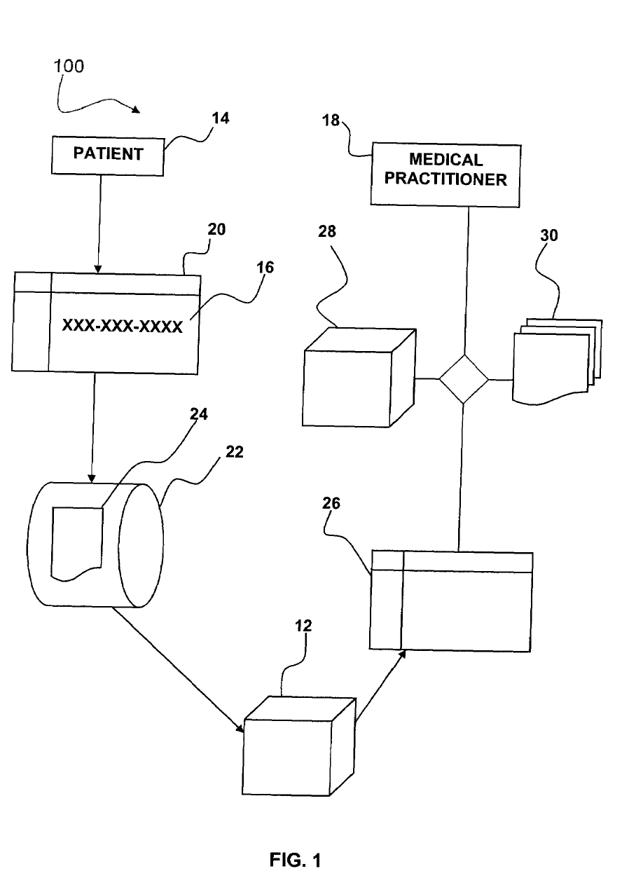

Referring to FIG. 1, a flow chart of the method is shown and described. The method 100 comprises analysis between parties utilizing computer software 12. In step 1 of the preferred embodiment of the method 100, a patient 14 acquires a vanity phone number 16 corresponding to a medical practitioner 18 from a website 20. The phone call made with the vanity phone number 16 is automatically documented and saved securely in a database 22, wherein the documented phone calls 24 are digitally recorded.

Referring to the components of step 2 in FIG. 1 of the method 100, computer software 12 communicates with the database 22 to securely download compiled documentation 24 corresponding to patient 14 phone calls.

The method components of step 3 shown in FIG. 1, comprise a secure website interface 26, accessible by devices 28 having internet access, provide medical practitioners 18 with patient 14 documentation 24, including: digital sound files, phone call logistics, including date and time of call, length of call, and caller phone number.

In step 4 of the current embodiment of the method shown in FIG. 1, medical practitioners 18 assign additional information 30 about patients 14 from the secure website interface 26 including: purpose of call, call outcomes, additional booking leads, patient condition, gender and social demographics, marketing source, revenue generated, treatment history, and condition to be treated. The secure website interface application also provides a means for downloading data from the medical practitioner's 26 other existing software.

In step 5 of the method 100 shown in FIG. 1, the computer software 12 comprising the web analytics application comprises a means for generating statistical information 30 based on the fields. In the preferred embodiment of the web analytics application, manual and/or automatic customization features for medical practitioners 18 include: all fields in the secure website interface 26, as well as relative new patient leads booking an appointment, relative booking percentage by condition, percentage and number of new patient leads booking an appointment, percentage and number of existing patient bookings generated, percentage and number of calls going to the answering service, percentage and number of calls hanging up, percentage and number of calls from telemarketers. In an alternative embodiment, fields can be generated based on anonymous visitor data including geographic location based on the IP address.

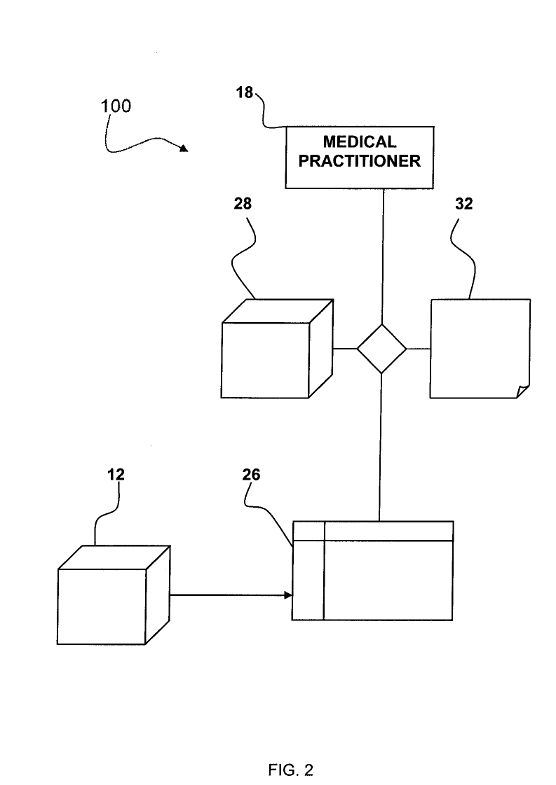

In step 6, shown in FIG. 2, the computer software 12 comprising the web analytic application of the method 100, comprises a means for allowing medical practitioners 18 to compare results with other participating medical practitioners 18 by generating anonymous comparative statistical analysis 32 based on the same fields input. The analysis comprises visual data representations.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method for analyzing the quality of patient-staff interaction for a medical practice comprising the steps of:
a patient interacting a with website comprising at least one phone number corresponding to at least one assigned physician, wherein the phone number called and a recording of the call and call conversation is stored in at least one database;
a computer software accesses the database for the stored content, wherein the content corresponds to the at least one physician;
providing stored data on a website interface for access by the at least one physician, wherein available information includes: digital sound files, phone call logistics including date of call, time of call, length of call, and phone number;
a website interface for the at least one physician, the physician assigning additional information about the patient chosen including purpose of call, call outcomes, additional booking leads, patient condition, gender and social demographics, marketing source, revenue generated, treatment history, and condition to be treated;
generating at least one analysis of patient information from the website interface comprising software with an analytics application; and
assessing a physician's performance comparatively by generating analysis involving at least two physicians.

2. The method of claim 1, wherein the website interface for the at least one physician provides a means for downloading data from the medical practitioner's other existing internal patient management or billing software;

3. The method of claim 1, wherein the phone call is securely documented and retrieved to and from the database created with SQL Server, Oracle, MySQL, SQLite, and/or DB2.

4. The method of claim 1, wherein the computer software to access the database is created with PHP, Java, Ruby, Python, C++, Perl, and/or .NET languages such as C# and VB.NET.

5. The method of claim 1, wherein the recording of the call is provided by third-party vendors.

6. The method of claim 1, wherein the website interface is accessible by personal computers, handheld devices, cell phones, and mobile devices having internet access.

7. The method of claim 1, wherein the generated analysis creates visual data representations.
